(19) United States
(12) Patent Application Publication
(10) Pub. No.: US 2004/0184746 A1
(43) Pub. Date: Sep. 23, 2004

(54) Fiber optic connector extension for transmission of digital video data

(76) Inventors: Chin L. Chang, Walnut, CA (US); Chung-Chien Chen, Rowland Heights, CA (US); Trong-Huang Lee, Walnut, CA (US)

Correspondence Address: ELLIOTT N. KRAMSKY, Esq., Suite 400, 5850 Canoga Avenue, Woodland Hills, CA, 91367, US

(21) Appl. No.: 10/388,990

(22) Filed: Mar. 17, 2003

(51) Int. Cl. G02B 6/44

(52) U.S. Cl. 385/100

(57) ABSTRACT

Apparatus for extending the range of effective communication of high speed digital video data between remote devices, such as a microprocessor and a flat panel display, having associated DVI standard connectors. A fiber optic cable comprising a plurality of fibers provides optical paths for signal transmission between the DVI connectors. Electrooptic converters are provided for converting the electrical signals sent and received by each of the connectors to optical form for transmission over the optical fiber cable.

### BACKGROUND

1. Field of the Invention

The present invention relates to apparatus for interfacing a digital full color video signal source with a display. More particularly, this invention pertains to apparatus for extending the range of transmission of digital video signals between such a source and a display.

2. Description of the Prior Art

Microprocessors and other devices that generate digital signals are commonly employed in conjunction with remote peripheral devices. Often such peripherals are required for providing inputs or outputs to be processed. Examples of input peripherals include keyboards and mouses while output peripherals include printers and displays.

Peripherals are commonly linked to the microprocessor by means of cables for engaging particularized microprocessor ports. The ports are configured to receive data output from a particular device that may or not require processing or buffering prior to processing within the microprocessor. Alternatively, ports may configure data generated within the microprocessor so that it can be utilized by, and thereby activate, the peripheral device.

Convenience of use and other factors often make it desirable to locate peripheral devices some distance from the microprocessor. Peripherals that operate with relatively low speed digital signal outputs and inputs are able to tolerate transmission of digital signals over relatively long distances over relatively-lossy cables of copper without significant degradation of function.

The situation is quite different for peripherals that receive digital signals for generating video images at a remote display. The transmission of video inputs in the form of digital signals is required for such peripherals as flat panel displays. Such displays, which employ a pixel matrix of liquid crystal material, gas plasma cells or LED arrays, differ from those that generate images by means of an analog signal-driven cathode ray tube (CRT) that employs an electron gun which is scanned across a phosphor screen to generate an image. Such CRT-driven displays provide images that are subject to flicker and consume significantly greater power than flat panel displays.

Data rates in the range of hundreds of megabits per second are required to drive displays of the flat panel type. While such rates may be reduced by data compression, this is undesirable or unacceptable for many applications (e.g. head-up cockpit display) as it prevents real time display of data. Further, real time transmission of digital video data is required by Digital Visual Interface revision 1.0 promulgated Apr. 2, 1999 by the Digital Display Working Group (hereinafter referred to as “the DVI standard”)

Prior art transmissions of high speed digital video between computer and display-have generally taken place over a DVI standard-compatible cable of copper conductors and have been found to degrade such data significantly as the length of the copper cable is increased. For example, it has been recognized that the maximum distance that can be transmitted by copper at HDTV (1920×1080 pixels) resolution without suffering serious degradation in video quality does not exceed ten (10) meters. Such a limit has also been found to exist for the common “RGB” cable in which digital-to-analog and analog-to-digital conversions take place at either end with the signal transmitted in analog form along a cable of copper conductors therebetween. Such limitation upon the physical distance separating computer from flat panel display places often-significant design limitations upon numerous applications and potential applications (e.g. the routing of cabling within an aircraft).

### SUMMARY OF THE INVENTION

The preceding and other shortcomings of the prior art are addressed by the present invention that provides, in a first aspect, apparatus for generating video images on a display device arranged in accordance with a digital video standard. Such apparatus includes a processor for generating a plurality of digital electrical signals, including a first transmission protocol signal, in accordance with the predetermined video standard.

A first connector, including a plurality of pins, is provided for receiving and directing each of the digital electrical signals to a predetermined pin and for receiving a second digital electrical transmission protocol signal at a predetermined pin. A second connector includes a plurality of pins arranged to receive each of the digital electrical signals, direct each of such signals to a predetermined portion of an input port of the display device, receive the second digital electrical transmission protocol signal from the display device and direct the transmission protocol signal to a predetermined pin of the second connector.

An electrical-to-optical converter circuit receives the plurality of digital electrical signals and generates a plurality of digital optical signals in response. The converter also receives a digital optical signal and generates the second digital electrical transmission protocol signal in response. An optical-to-electrical converter circuit receives the digital optical signals and converts them to the plurality of digital electrical signals and converts the second digital electrical transmission protocol signal to a digital optical signal.

An optical cable is in optical communication with the electrical-to-optical converter circuit and with the optical-to-electrical converter circuit. The optical cable includes a plurality of optical fibers for transmitting the optical signals between the electrical-to-optical converter and the optical-to-electrical converter.

In a second aspect, the invention provides apparatus for communication of a bidirectional digital electrical signal, comprising sequential forward and reverse transmissions, between a bidirectional port of a first device and a bidirectional port of a second device. The first and second devices are remote from one another.

Such apparatus includes an electrical-to-optical converter circuit for receiving a forward electrical signal and generating a forward digital optical signal in response and for receiving a reverse digital optical signal and generating a reverse digital electrical signal in response. An optical-to-electrical converter circuit is provided for receiving the forward digital optical signal and converting it to the for-ward digital electrical signal while converting the reverse digital electrical signal to the reverse digital optical signal.

An optical cable is in optical communication with the electrical-to-optical converter and with the optical-to-electrical converter. Such optical cable includes a plurality of optical fibers for transmitting the optical signals between the electrical-to-optical converter and the optical-to-electrical converter.

The foregoing and other features of the invention will become further apparent from the detailed description that follows. Such description is accompanied by a set of drawing figures. Numerals of the drawing figures, corresponding to those of the written description, point to the features of the invention. Like numerals of the drawing figures and written text point to like features of the invention throughout.

### BRIEF DESCRIPTION OF THE DRAWINGS

FIGS. 1(a) and 1(b) illustrate real time digital video display systems in accordance with the prior art and the invention respectively;

FIG. 2 is a block diagram of the transmitter module of a fiber optic real time digital video extension module in accordance with the invention;

FIG. 3 is a block diagram of the receiver module of a fiber optic real time digital video extension module in accordance with the invention;

FIG. 4 is a schematic diagram of a directional logic circuit in accordance with the invention; and

FIGS. 5(a) and 5(b) are timing diagrams for illustrating forward and reverse transmission components of a bidirectional transmission protocol signal DDC_Data in accordance with the DVI standard.

### DETAILED DESCRIPTION OF THE PREFERRED EMBODIMENT

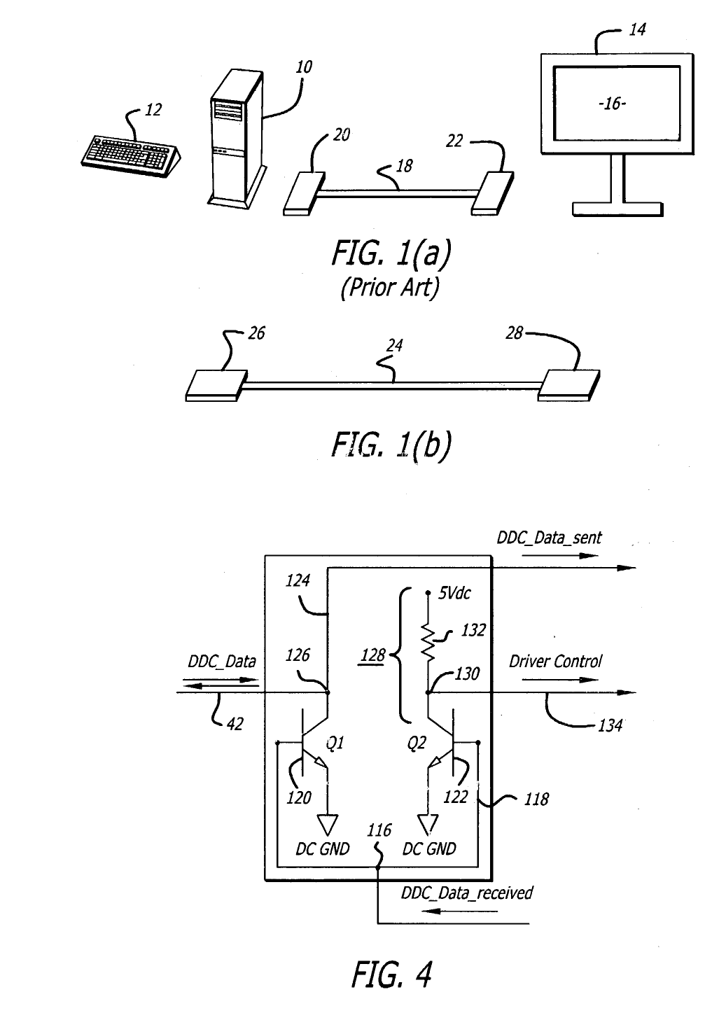

FIGS. 1(a) and 1(b) illustrate real time digital video display systems in accordance with the prior art and the invention, respectively. Each of the systems is provided for high speed transmission of digital data output, for example, by a processor 10. The processor 10 comprises a device for generating, receiving and processing digital signals including, but not limited to, a microprocessor, video processor or the like. The data can be generated in response to having inputs provided, for example, by a keyboard 12. A display device 14 is arranged for generating corresponding video images on a screen 16. In addition to the high speed video data provided to the display device 14, relatively low speed data must be exchanged between the processor 10 and the display device 14 to assure that the data transfer process occurs properly. Such low speed data transmission permits the processor 10 to learn the identity of the display device 14 to thereby configure the video data output accordingly and in accordance with the peculiarities of the display device 14. Additionally, the microprocessor 10 must be informed of changes in either the identity or status of the display device 14, error messages and completion data, etc. The signal transmissions required of both processor and display device manufacturers to assure interoperability between equipment of different origins are regularized by means of standards established by industry organizations. For example, communication between personal computers and flat panel displays is regulated by the DVI standard. For purposes of illustration only, the discussion of the invention will proceed in accordance with such standard although it will be recognized that the teachings of this invention are not limited to interactions between a processor and a display device nor to communications in accordance with the DVI standard.

Both high speed digital video and relatively low speed digital transmission protocol data are transmitted between processor 10 and display device 14 over a common transmission link. In the prior art, such transmission (without conversion to analog form) has typically taken place over a cable 18 comprising a plurality of copper conductors as illustrated in FIG. 1(a). The cable 18 is terminated at either end by 24-pin DVI connectors 20 and 22. The DVI connector 20 comprises a hardware arrangement for receiving digitized video data output from the processor 10, which includes a video card that processes inputs from the processor 10 into proper digitized video signals, and directing such digitized video signals to pins whose locations are determined in accordance with the DVI standard. Conversely the DVI connector 22 is arranged to receive the outputs from the DVI connector 20 at predetermined pins and to direct the signals to standardized pin locations within an input port of the display device 14 whereby such input signals may be properly processed to generate images on the screen 16 of the display device 14. Additionally, it will be seen that each of the DVI connectors 20 and 22 includes a pin adapted to receive and transmit a bidirectional signal that contains transmission protocol information in digital form.

FIG. 1(b) illustrates a system for digital transmission of real time video information between the processor 10 and the display device 14 in accordance with the invention that significantly extends the effective operational separation distance therebetween. Such device comprises a cable 24 of optical fibers having an electrooptic transmitter 26 at one end and an electrooptic receiver 28 at the other end. As will be discussed below, the electrooptic transmitter 26 includes the DVI connector 20 while the electrooptic receiver 28 includes the DVI connector 22, each in combination with additional electrical-to-optical and optical-to-electrical converter circuitry, respectively, for rendering the standard-mandated digital signal exchange between processor 10 and display device 14 compatible with an optical fiber transmision medium. As a result, the range or separation distance between processor 10 and display device 14 is extended much beyond the approximately ten meter limitation of copper cable transmission. Transmission of signals in accordance with the DVI standard over 1000 meters has been observed with no noticeable degradation in video signal quality.

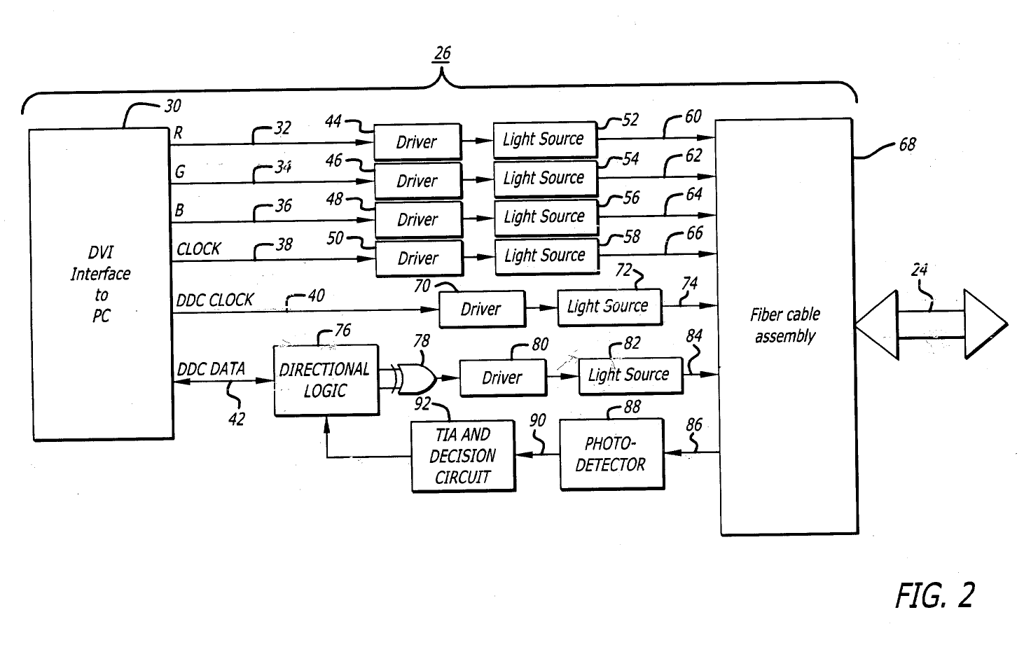

FIG. 2 is a block diagram of the electrooptic transmitter 26 of the invention. The transmitter 26 receives and converts electrical signals that have been formatted in accordance with the DVI standard for transmission to a display device 14 such as a flat panel display. The transmitter 26 incorporates a DVI connector 30 that is identical to the DVI connector 20 employed in prior art arrangements in conjunction with a copper cable.

The outputs of, and inputs to, the DVI connector 30, originating and received at both the processor 10 and the display device 14, are identical to those of the prior art arrangement that includes a copper cable with limited digital video signal transmission range. Unlike the prior art, digital video signal transmission takes place over the cable 24 that comprises a plurality of longitudinally-arranged optical fibers resulting in greatly-increased effective signal transmission range between the processor 10 and the display device 14. Such enhanced transmission range is accomplished by substituting an optical fiber cable for a cable of copper conductors and preparing the electrical signals received by and transmitted from the DVI connector 30 for “seamless” integration into the optical transmission system.

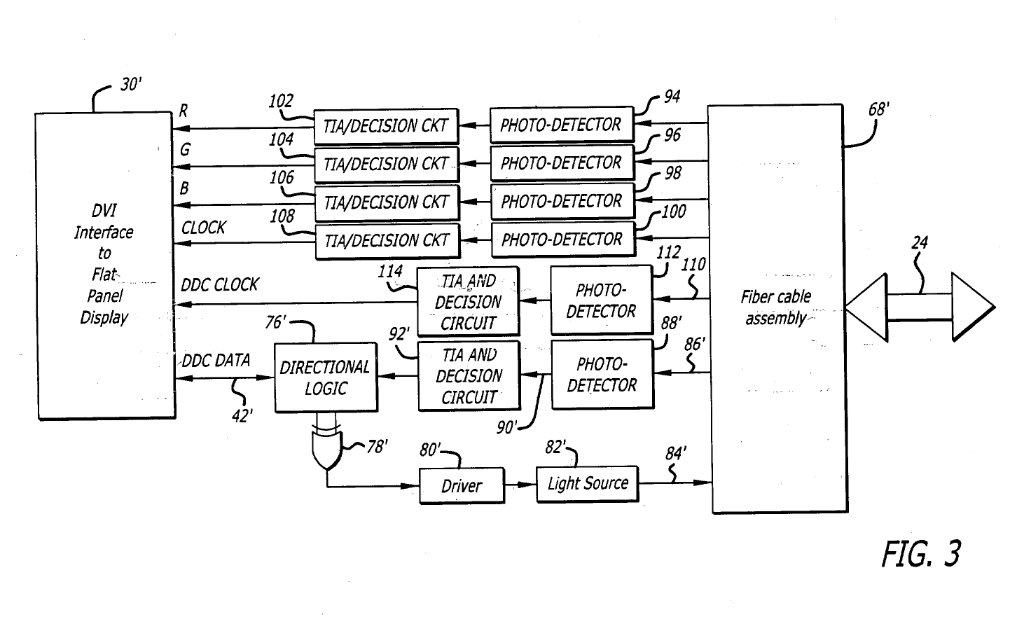

While proceeding through a discussion of the elements of the electrooptic transmitter 26, it should be kept in mind that the processes described in conjunction, with the elements and arrangements of the transmitter 26 essentially take place in mirror image at the other end of the fiber optic cable 24 where an electrooptic receiver 28 is provided at the other end of the cable 24 for interacting with the display device 14. Such an electrooptic receiver 28 is illustrated by the block diagram of FIG. 3. Just as in the case of the electrooptic transmitter 26, the receiver 28 includes a DVI connector 30′ conforming to an appropriate DVI standard that may be seen, for purposes of discussion, to be identical to the connector 22 employed in conjunction the copper cable 18 of the prior art. As such, apparatus is provided at the display device 14 end of a digital video signal transmission for conversion of the electrical signals output by and received at the DVI standard connector 30′ to and from optical mode. Accordingly, essentially identical technical arrangements are provided in the invention at each end of the optical fiber cable 24. For this reason, elements of the electrooptic receiver 28 corresponding to those of the electrooptic transmitter 26 are indicated by primed numeral of the corresponding element of the transmitter 26.

Returning to FIG. 2, the DVI connector 30 receives data from the processor 10 containing information that is then formatted by it and output as electrical signals defining a full color transmission. That is, the DVI connector 30 provides a “red information” signal on a first electrical conductor 32, a “green information” signal on a second electrical conductor 34, a “blue information” signal on a third electrical conductor 36 and a “pixel clock” signal on a fourth electrical conductor 38. (Note, frame synchronization information is included within one of the red, green or blue information signals.)

The DVI connector 30 additionally provides signals that are required by the applicable DVI standard for both enabling and regulating the effective communication of high speed digital video data from a processor 10 for display as images on a display device 14. A relatively low speed transmission protocol clock signal (“DDC clock”) that controls and synchronizes the transmission of such transmission protocol signals is transmitted on an electrical conductor 40.

The transmission protocol communication between the processor 10 and the display device 14 in accordance with the applicable DVI standard is sent and received on an electrical conductor 42. Such communication is two-way as, in accordance with the physical configuration of the, DVI connector 30, it involves a single port that must accommodate transmissions both by and from both the processor 10 and the display device 14. The provision of two-way transmissions over a single electrical conductor involves merely the provision of signal headers and the like for identifying the direction of transmission. It will be seen that the present invention addresses the much more significant issues that arise when optical signal transmissions are involved.

Each of the signals output on the electrical conductors 32 through 42 comprises a high speed transmission of digital data. The prior arrangement may be thought of as essentially the direct interconnection of a pair of DVI connectors through electrical connectors. In the invention, much greater separation is obtained between the two DVI connectors by employing an optical transmission medium.

The conversion of the high speed digital video electrical signals output on the electrical conductors 32 through 36 is accomplished by applying such signals to drivers 44 through 50 arranged to trigger light sources 52 through 58 (preferably of the VCSEL type arranged to emit 850 nm light) respectively whereby the light sources 52 through 56 output high speed optical digital video signals that carry the red, green and blue information required to generate a frame of an image on the screen 16 of the display device 14 while the light source 58 generates digital optical video clock signals(s) as referenced above. Such high speed digital optical signals are capable of greater than one kilometer transmission over optical fiber without significant degradation. While representing an extremely significant increase in the range of transmission of high speed video signals, the range of transmission of signals over an optical medium will vary in accordance with the types of light sources and optical fiber employed. For example, the outputs of light sources of the VCSEL, LED or Fabry-Perot type can transmit high speed digital signals over a range of up to approximately 2 kilometers over multi-mode optical fiber. On the other hand, much greater ranges are possible when single mode fiber is employed. While light output from a LED cannot be coupled into single mode fiber, high speed digital signals output onto single mode fiber from a VCSEL light source may be transmitted up to approximately 10 kilometers and those output from a Fabry-Perot light source are capable of transmission up to approximately 50 kilometers. High speed digital signals output from a, distributed feedback (DFB) laser light source onto single mode optical fiber may be transmitted up to approximately 100 kilometers.

The optical signals output from the light sources 52 through 58 are carried on optical fibers 60 through 66 respectively and are received at a multimode fiber cable assembly 68. The fiber cable assembly 68 receives the individual optical fibers and gathers them, at its exterior, into the fiber optic cable 24. Alternatively, the fiber cable assembly 68 may be thought of as receiving a stripped end of the fiber optic cable 24 and separating the individual fibers of the cable 24 from one another at its interior so that the ferruled ends of the individual fibers may be directed and joined to light sources and photodetectors in accordance with the architecture of the invention.

A driver 70 receives the digital electrical DDC clock signal transmitted along the electrical conductor 40 and responsively actuates a light source 72, which may be a LED arranged to output 1310 nm light rather than a VCSEL due to the much slower speed of the DDC clock signal as opposed to that of the video information and video clock signals, whereby the light source 72 outputs a digital optical DDC clock signal on an optical fiber 74 that is received at the fiber cable assembly 68.

The bidirectional digital transmission protocol signals carried on the electrical conductor 42 are split by means of a directional logic circuit 76 in communication with the electrical conductor 42 for transmission along two separate branches of the electrical-to-optical circuit. This reflects the fact that, while the DVI standard allows transmission of the DDC_data transmission protocol signal in two directions over a single electrical conductor, the optical signals must be carried over separate circuit branches. That is, while a DDC_data signal is applied in a forward direction to a light source through a driver located in a first circuit branch, a DDC_data signal in the reverse direction is received at transimpedance amplifier/decision circuit over a second branch that includes a photodetector. As such, separate paths or branches must exist, one for sending an optical signal from a first light source in one direction to a first photodetector and another for sending an optical signal from a second light source in the opposite direction to a second photodetector to perform the required mimicking of bidirectional electrical signal transmission over a single electrical conductor.

The directional logic circuit 76 serves to split and recombine a bidirectional electrical DDC_Data signal into two one-way transmissons of transmission protocol information between the DVI connectors 30 (and, thus, the microprocessor 10) and 30′ (and the associated display device 14). By splitting the bidirectional DDC Data signal into two one-way signals, the bi-directional signal communication of this information over the fiber optic cable 24 is facilitated. As the applicable DVI standard and existing DVI connectors 30 and 30′ are configured to receive DDC Data at a single bidirectional port, it is essential that the fragmenting and reassembly of this bidirectional electrical signal be invisible at the DVI connectors 30 and 30′.

An electrical signal containing transmission protocol information output from the DVI interface 30 onto the electrical conductor 42, when passed through the directional logic circuit 76, continues and is applied to a logic circuit 78 where it is EXCLUSIVE OR'ed with a control signal, discussed below, that is internally generated by the directional logic circuit 76. The output of the logic gate 78 provides an electrical signal that is input to a driver 80 that, in turn, controls a light, source 82 which, again may comprise a LED arranged to output 1310 nm light. Upon receiving a triggering signal from the driver 80, the light source is activated to output digital transmision protocol information corresponding to the electrical signal from the DVI connector 30 onto the electrical conductor 42. The optical signal from the light source 82 is transmitted through an optical fiber 84. The optical signal carried by the optical fiber 84 is optically coupled by the fiber cable assembly 68 onto a fiber of the optical cable 24 for transmission to the remote receiver connector 28.

Incoming transmission protocol information in the form of an optical digital signal is received at the fiber cable assembly 68 wherein it is coupled to the end of an optical fiber 86 and transmitted to a photodetector 88. The photodetector 88 generates an electrical signal in response that is transmitted on an electrical conductor 90 to a transimpedance amplifier/decision circuit 92 which converts the relatively small current generated by the photodetector 88 into a voltage which it then amplifies. Thereafter, the circuit 92 determines the state of the incoming signal as “0's” or “1's” by means of post amplifiers and comparators to generate a relatively low speed digital electrical transmission protocol signal for application to the directional logic circuit 76. As stated above, the directional logic circuit 76 is arranged to selectively block or permit passage of the incoming digital electrical transmission protocol signal to the DVI connector 30 to assure that the bidirectional transfer of transmission protocol information between the microprocessor 10 (and associated DVI connector 30) and the digital display device 14 (and associated DVI connector 30′) takes place seamlessly over a much greater range than is possible with a prior art arrangement in accordance with FIG. 1(a).

Reviewing the arrangement of the electrooptic receiver 28 of FIG. 3, it will be understood that the incoming optical signal containing transmission protocol information received and transmitted over the optical fiber 86 is generated at the light source 82′ of the electrooptic receiver 28.

Referring to the block diagram of the electrooptic receiver 28 of FIG. 3, it can be seen that the optical digital video signals generated a the light sources 52 through 58 of the electro-optic transmitter 26 are received over the fiber optic cable 24 at the fiber cable assembly 68′ whereupon they are optically coupled to fibers that transmit such signals to photodetectors 94 through 100, thereby generating corresponding electrical currents that are converted into high speed digital video electrical signals by means of transimpedance amplifier/decision logic circuits 102 through 108 respectively. The outputs of the transimpedance amplifier/decision logic circuits 102 through 108 are sent over electrical conductors whereby such high speed digital video signals, corresponding to the high speed electrical digital video signals output from the DVI connector 30 along the electrical conductors 32 through 38 of FIG. 2, are received at the appropriate ports of the DVI connector 30′.

A fiber 110 is optically coupled at the fiber cable assembly 68′ to the fiber of the cable 24 that transports the digital optical signal output by the light source 72 of the electrooptic transmitter 26 carrying the DDC clock signal. Such digital optical signal is applied to a photodetector 112 for generating a corresponding electrical current that is converted into a digital electrical signal at a transimpedance amplifier/decision logic circuit 114 that is then transmitted on an electrical conductor to the appropriate port of the DVI connector 30′. This digital electrical signal corresponds to the digital electrical DDC clock signal output by the DVI connector 30 on the electrical conductor 38 of FIG. 2.

The remainder of the circuitry of the electrooptic receiver 28 is indicated by primed numerals to indicate correspondence to elements of the electrooptic transmitter 26. Such structural symmetry reflects the fact that the combination of the elements 76 through 92 and 76′ through 92′, in combination with the fiber cable assemblies 68, 68′ and the optical cable 24, functions to preserve the bidirectional transmission of low speed digital electrical transmission protocol signals between the microprocessor 10 and the display device 14.

FIG. 4 is a schematic diagram of a directional logic circuit 76, 76′ in accordance with the invention. Such a circuit, as mentioned above, is essential to the integration of a fiber optic link that extends the range over which DVI connectors 30 and 30′ (and, therefore, the microprocessor 10 and the display device 14) can successfully communicate high speed real time video information in accordance with applicable DVI standards. The directional logic circuit 76, 76′, as mentioned earlier, splits a bidirectional electrical transmission protocol signal, DDC-Data into two single-directional electrical component signals (DDC_Data sent, DDC_Data_received). By splitting the bidirectional electrical signal into two single-directional components, DDC-Data is made suitable for transmission over an optical medium (i.e., over two optical fiber paths, one for sending and the other for receiving). Thereafter, the directional logic circuit 76 recombines the two components onto a single electrical conductor in such a way that the DVI standard and the physical limitations of existing DVI connectors requiring receipt and transmission of transmission protocol information through a single bidirectional port are met.

Referring to the internal arrangement of the circuit 76 (the operation and arrangement of the directional circuit 76′ are identical), a first node 116 is provided in a conductor 118 that joins the bases of bipolar transistors 120 and 122 for receipt of an incoming DDC_Data_received signal sent from the DVI connector 30′. Each of the bipolar transistors is of the npn type with emitter grounded.

The collector side of the transistor 120 communicates with a conductor 124 having a node 126 in communication with the electrical conductor 42 that communicates with the bidirectional port of the DVI connector 30 that sends and receives the DDC_Data transmission protocol information signals. The collector side of the transistor 122 is connected to a circuit branch 128. A d.c. voltage source (e.g. +5 Vdc) is located at the remote end of the circuit branch. A node 130 is intermediate the transistor 122 and the voltage source while a resistor 120 is located between the voltage source and the node 130.

In operation, the circuit comprising the circuit branch 128 and the transistor 122 functions to regulate the voltage level of the node 130. That is, the level of the node 130 is, for example, +5 Vdc when the transistor 122 is not conducting or “off” and somewhat lower, due to the dissipation of energy as current flows through the resistor 132, when the transistor 122 is conducting or “on”.

A Driver control signal is tapped from the node 130 onto a conductor 134. This signal provides one of the inputs to the logic circuit 78 mentioned with reference to FIG. 2. The other input to the logic circuit comprises the DDC_Data_sent signal. The Driver control signal is EXCLUSIVE OR'ed with the DDC_Data_sent signal at the logic circuit 78. The output of the logic circuit 78 is applied to the driver 80 that controls the output of the light source 82 which constitutes the forward transmission of transmission protocol information in the form of a digital optical signal.

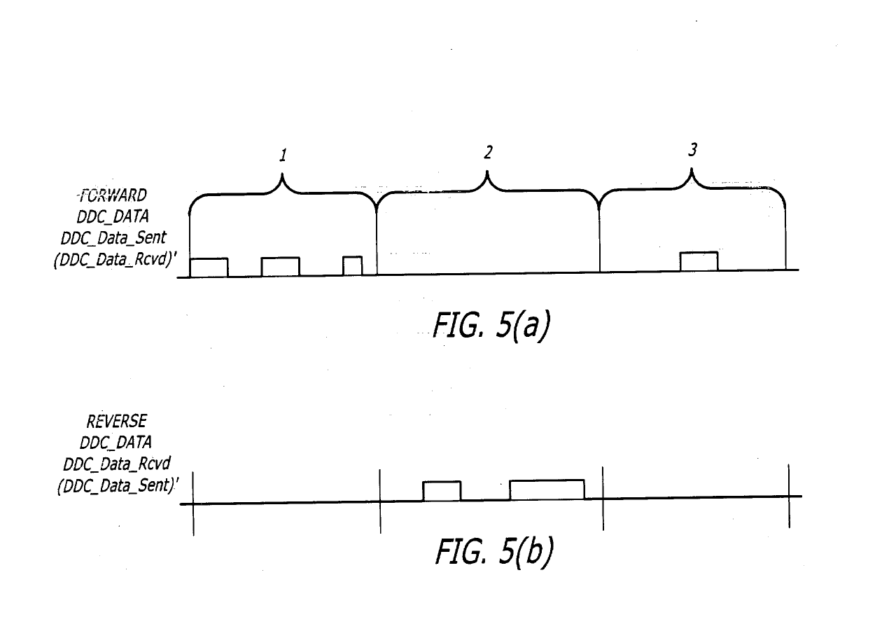

The Driver control signal will be seen to be essential to the proper functioning of the system. The basic format of the bidirectional signal DDC-data is illustrated by the timing diagrams of FIGS. 5(a) and 5(b). FIG. 5(a) illustrates the forward transmission of DDC_Data while FIG. 5(b) illustrates the receipt of DDC-Data with respect to the DVI connector 30. (Note, the opposite situation exists with respect to the DVI connector 30′.) Periods “1” and “3” have been reserved or dedicated to transmission of data from the DVI connector 30 while period “2” is dedicated to receipt of data at the connector 30. (Note: the durations of periods 1, 2, 3, etc. are established and specified by the DVI standard.) It may be noted that forward DDC Data transmissions are characterized by bi-level digital data separated by a dormant (low or logic “0” level) period during which bi-level DDC_Data is transmitted in the reverse direction.

Returning to the directional logic circuit 76 as illustrated in FIG. 4, such circuit is arranged so that DDC_Data_sent is applied to the driver 80 during forward transmission periods such as periods 1 and 3 while reverse transmissions of DDC_Data (DDC_Data_received) are only received at the DVI connector 30 during receipt periods such as period 2. Such operation is achieved as follows. During a forward transmission of DDC Data (e.g., period 1 or 3), the DDC_Data_received signal is low (period 2). The transistors 120 and 122, each of which acts as an inverter of such signal at the nodes 126 and 130, is off. As a result, the node 130 remains high (at the level of the +5 Vdc source) representing a logical “1”. This logic state is transmitted to the logic circuit 78 as the Driver control where it is EXCLUSIVE OR'ed with the DDC_Data_sent. This results in the following:

| DDC_Data | DDC_Data_sent | Driver Control | Light Source |
|---|---|---|---|
| 1 | 1 | 1 | OFF |
| 0 | 0 | 1 | ON |

From the above, it can be seen that the light source 82 is responsive to the DDC_Data_sent signal during forward transmission of DDC_Data. (The light source 82 is arranged to output a light pulse in response to a logical “0” and to output no light in response to a logical “1” of the transmitting DDC_Data signal on the assumption that the majority of the content of the forward transmissions of DDC_Data will be low or logical “0”.

During periods of reverse transmission of DDC_Data (e.g. period 2), the transistors 120 and 122 will be turned on by the arrival of logical “1's” in the DDC_Data-received signal at the node 116 and turned off by the arrival of logical “0′” in the reverse transmission. A logical “1” will turn on the transistors 120 and 122, driving the nodes 126 and 130 low. When this occurs, such a low level is seen at the DVI connector 30 and properly interpreted as the transmission of a logical “1” from the DVI connector 30′. When a logical “0” of the DDC_Data_received signal arrives at the node 116 during period 2, the transistor 120 is turned off and a logical “1” is seen at the node 126 that is properly interpreted by the DVI connector 30 as the transmission of a logical “0” from the DVI connector 30′.

In the latter case, the Driver control signal is driven high as the transistor 122 is turned off by the arrival of a low level signal at the base of the transistor. In the situation illustrated in the prior table, a high level of the Driver control signal permitted transmission of the DDC_Data_sent signal. Forward transmission of DDC_Data_received is, of course, to be avoided and it is prevented by the EXCLUSIVE OR'ing of the Driver control signal with the inverted DDC_Data_received signal at the logic circuit 78. That is, Driver control is always the same as the inverted DDC_Data_received signal and so it can never pass through the logic circuit 78 to be applied to the driver 80 to trigger a forward transmission from the light sources 82. This mode of operation is summarized as follows:

| DDC_Data_received | DDC_Data | Driver Control | Light Source |
|---|---|---|---|
| 1 | 0 | 0 | OFF |
| 0 | 1 | 1 | OFF |

Thus, the directional logic circuit 76 (and 76′) permits the unmodified operation of existing DVI connectors 30, 30′ with greatly extended communication capabilities in a seamless fashion. Accordingly, the present invention provides apparatus for extending the range of transmission of high speed digital signals. By employing the teachings of the invention, one may realize the advantages of substantially extended range between a processor and display device, for example, without incurring the substantial investment and security risks associated with such alternative means as microwave links.

While the invention has been described with reference to its presently-preferred embodiment, it is hot limited thereto. Rather this invention is limited only insofar as it is described by the following set of patent claims and includes within its scope all equivalents thereof.

What is claimed is:

1. Apparatus for generating video images on a display device arranged in accordance with a digital video standard comprising, in combination:
a) a processor for generating a plurality of digital electrical signals in accordance with said predetermined video standard, said plurality of digital electrical signals including a first transmission protocol signal;
b) a first connector, including a plurality of pins, for receiving and directing each of said digital electrical signals to a predetermined pin and for receiving a second digital electrical transmission protocol signal at a predetermined pin;
c) a second connector including a plurality of pins arranged to receive each of said digital electrical signals, direct each of said signals to a predetermined portion of a port of said display device and to receive said second digital electrical transmission protocol signal from said port of said display device and direct said transmission protocol signal to a predetermined pin of said second connector;
d) an electrical-to-optical converter circuit for receiving said digital electrical signals and generating a plurality of digital optical signals in response thereto and for receiving a digital optical signal and generating said second digital electrical transmission protocol signal in response thereto;
e) an optical-to-electrical converter circuit for receiving a plurality of digital optical signals and converting said signals to said plurality of digital electrical signals and for converting said second digital electrical transmission protocol signal to a digital optical signal;
f) an optical cable in optical communication with said electrical-to-optical converter and said optical-to-electrical converter; and
g) said optical cable including a plurality of optical fibers for transmitting said optical signals between said electrical-to-optical converter and said optical-to-electrical converter.

2. Apparatus as defined in claim 1 wherein said electrical-to-optical converter circuit further includes:
a) a first branch for receiving a digital optical signal and converting said signal to said second digital electrical transmission protocol signal;
b) a second branch for receiving said first digital electrical transmission protocol signal and converting said signal to a digital optical signal; and
c) a directional logic circuit in communication with said first connector and with said first and second branches for preventing receipt of said second digital electrical transmission protocol signal at said processor during a transmission mode and for preventing transmission of said first digital electrical transmission protocol signal during a receiving mode.

3. Apparatus as defined in claim 2 wherein said second branch of said electrical-to-optical circuit further includes:
a) a light source; and
b) said light source being controlled by the output of a logic circuit; and
c) the inputs to said logic circuit being said first transmission protocol signal and the inverse of said second transmission protocol signal.

4. Apparatus as defined in claim 3 wherein said logic circuit comprises an EXCLUSIVE OR gate.

5. Apparatus as defined in claim 4 wherein said directional logic circuit includes:
a) a first node for receiving said second transmission protocol signal;
b) a second node for receiving said first transmission protocol signal and the inverse of said second transmission protocol signal; and
c) a third node for receiving the inverse of said second transmission protocol signal.

6. Apparatus as defined in claim 5 wherein the inputs to said EXCLUSIVE OR gate comprise the values at said second and third nodes.

7. Apparatus as defined in claim 1 wherein said plurality of electrical signals additionally comprise red, blue and green information.

8. Apparatus as defined in claim 1 wherein said plurality of electrical signals additional comprises a pixel clock.

9. Apparatus as defined in claim 1 wherein said plurality of electrical signals additionally comprises a transmission protocol clock.

10. Apparatus as defined in claim 1 wherein said optical-to-electrical converter circuit further includes:
a) a first branch for receiving a digital optical signal and converting said signal to said first digital electrical transmission protocol signal;
b) a second branch for receiving said second digital electrical transmission protocol signal and converting said signal to a digital optical signal; and
c) a directional logic circuit in communication with said second connector and with said first and second branches for preventing receipt of said first digital electrical transmission protocol signal during a transmission mode and for preventing transmission of said second digital electrical transmission protocol signal during a receiving mode.

11. Apparatus as defined in claim 10 wherein said second branch of said electrical-to-optical circuit further includes:
a) a light source; and
b) said light source being controlled by the output of a logic circuit; and
c) the inputs to said logic circuit being said second transmission protocol signal and the inverse of said first transmission protocol signal.

12. Apparatus as defined in claim 11 wherein said logic circuit comprises an EXCLUSIVE OR gate.

13. Apparatus as defined in claim 12 wherein said directional logic circuit includes:
a) a first node for receiving said first transmission protocol signal;
b) a second node for receiving said second transmission protocol signal and the inverse of said first transmission protocol signal; and
c) a third node for receiving the inverse of said first transmission protocol signal.

14. Apparatus as defined in claim 13 wherein the inputs to said EXCLUSIVE OR gate comprise the values at said second and third nodes.

15. Apparatus for communication of a bidirectional digital electrical signal, comprising sequential forward and reverse transmissions, between a bidirectional port of a first device and a bidirectional port of a second device, said first and second devices being remote from one another comprising, in combination:
a) an electrical-to-optical converter circuit for receiving a forward electrical signal and generating a forward digital optical signal in response thereto and for receiving a reverse digital optical signal and generating a reverse digital electrical signal in response thereto;
b) an optical-to-electrical converter circuit for receiving said forward digital optical signal and converting said signal to said forward digital electrical signal and for converting said reverse digital electrical signal to said reverse digital optical signal;
c) an optical cable in optical communication with said electrical-to-optical converter and said optical-to-electrical converter; and
d) said optical cable including a plurality of optical fibers for transmitting said optical signals between said electrical-to-optical converter and said optical-to-electrical converter.

16. Apparatus as defined in claim 15 wherein said electrical-to-optical converter circuit further includes:
a) a first branch for receiving said reverse digital optical signal and converting said signal to said reverse digital electrical signal;
b) a second branch for receiving said forward 8 digital electrical signal and converting said signal to -said forward digital optical signal; and
c) a directional logic circuit in communication with said first connector and with said first and second branches for preventing receipt of said reverse digital electrical transmission signal at said first device during a transmission mode and for preventing transmission of said forward digital electrical signal during a receiving mode.

17. Apparatus as defined in claim 16 wherein said second branch of said electrical-to-optical circuit further includes:
a) a light source; and
b) said light source being controlled by the output of a logic circuit; and
c) the inputs to said logic circuit being said forward digital electrical signal and the inverse of said reverse digital electrical signal.

18. Apparatus as defined in claim 17 wherein said logic circuit comprises an EXCLUSIVE OR gate.

19. Apparatus as defined in claim 18 wherein said directional logic circuit includes:
a) a first node for receiving said reverse digital electrical signal;
b) a second node for receiving said forward digital electrical signal and the inverse of said reverse digital electrical signal; and
c) a third node for receiving the inverse of said reverse digital electrical signal.

20. Apparatus as defined in claim 19 wherein the inputs to said EXCLUSIVE OR gate comprise the values at said second and third nodes.

21. Apparatus as defined in claim 15 wherein said optical-to-electrical converter circuit further includes:
a) a first branch for receiving said forward digital optical signal and converting said signal to said forward digital electrical signal;
b) a second branch for receiving said reverse digital electrical signal and converting said signal to said reverse digital optical signal; and
c) a directional logic circuit in communication with said second connector and with said first and second branches for preventing receipt of said forward digital electrical signal at said second device during a transmission mode and for preventing transmission of said reverse digital electrical signal during a receiving mode.

22. Apparatus as defined in claim 21 wherein said second branch of said electrical-to-optical circuit further includes:
a) a light source; and
b) said light source being controlled by the output of a logic circuit; and
c) the inputs to said logic circuit being said reverse digital electrical signal and the inverse of said forward digital electrical signal.

23. Apparatus as defined in claim 22 wherein said logic circuit comprises an EXCLUSIVE OR gate.

24. Apparatus as defined in claim 23 wherein said directional logic circuit includes:
a) a first node for receiving said forward digital electrical signal;
b) a second node for receiving said reverse digital electrical signal and the inverse of said forward digital electrical signal; and
c) a third node for receiving the inverse of said forward digital electrical signal.

25. Apparatus as defined in claim 24 wherein the inputs to said EXCLUSIVE OR gate comprise the values at said second and third nodes.
